(19) United States
(12) Patent Application Publication
(10) Pub. No.: US 2009/0121484 A1
(43) Pub. Date: May 14, 2009

(54) Wind energy conversion using the magnus effect

(76) Inventor: Edwin Newman, Palmdale, CA (US)

Correspondence Address: Edwin Newman, 2954 Nandina Dr., Palmdale, CA, 93550, US

(21) Appl. No.: 11/985,200

(22) Filed: Nov. 13, 2007

(51) Int. Cl. F03D 9/00; F03D 7/00

(52) U.S. Cl. 290/44; 290/55

(57) ABSTRACT

The invention comprises a wind energy conversion device. It is able to convert a far greater percentage of the pressure energy of the wind into electricity than by using an airfoil or even a sail. A Flettner Rotor is mounted atop special support structure which is far enough away from the Rotor to minimize turbulence around the Rotor. Thus the performance of the Rotor is enhanced. Energy conversion occurs as the Rotor is made to operate gears attached to an electric generator.

### BACKGROUND OF THE INVENTION

1. Field of the Invention

This invention relates to an electricity generating device and more specifically to one that is powered by the force of the wind.

2. Description of Prior Art

Air pressure at the earth's surface is 14.7 lbs./square inch. This is about a metric ton/square foot. So a cubic foot of air weighs about a metric ton. If this cubic foot of air is made to move 10 miles/hour then the power developed is over 56 horse-power. So theoretically wind energy can supply all of man's energy needs. There has been some progress towards extracting this energy. In order to do so at 100% efficiency a perfect vacuum must somehow be contrasted with normal air pressure. Airfoils are used to cause a mild pressure difference which is enough to lift aircraft, and in the form of a propeller to spin wind turbines to produce electricity.

Wind turbine efficiency is severely limited since a great deal of the wind energy blows through the propeller arc without affecting performance. Sails have been tried (see U.S. Pat. No. 7,157,805 to Mooring) and this is a step forward since all the kinetic energy of the wind may be processed by the device. Mooring points out the wind is forever changing its velocity. He mounts a square rig sail on a pole which serves as a long lever. As the sail is made to swing back and forth by the wind the lever is made to operate gears and springs to operate an electric generator.

But the problem remains to increase as much as possible the coefficient of drag and/or lift so more power can be produced over the same fromtal area of whatever shaped energy collector is atop the pole. Accordingly, it is the object of this invention to efficiently convert the absolute pressure energy of the wind into electricity.

### SUMMARY OF THE INVENTION

A Flettner Rotor is mounted atop a pole, with attendant motor. The pole serves as a lever which is made to operate a mechanical transmission on the ground, which in turn is made to operate a generator. Various hydraulic systems are also feasable such as described in my U.S. Pat. Nos. 6,781,253 and 7,043,904. With the use of a Flettner Rotor the coefficient of lift is greatly increased and therefor leads to an increase in power output compared to using a propeller or sail.

Power is only produced by this invention when the force on the lever is made to vary. There may be times when the wind is not gusting. But by varying the speed of the motor the lift force will be varied. The Rotor should have only a minimum mass so it is easier to accellerate and decellerate its spin.

The attainment of the foregoing and related objects, advantages and features of the invention should be more readily apparent to those skilled in the relevant arts indicated, after review of the following more detailed description of the invention, taken together with the drawings in which:

### BRIEF DESCRIPTION OF THE DRAWINGS

FIG. 1 is a perspective view of the invention, and

FIG. 2 is a top view of the rotor and shows the various forces upon it.

FIG. 3 is a perspective view showing a braking mechanism and relevant electrical circuitry.

### DETAILED DESCRIPTION OF THE PREFERRED EMBODIMENT

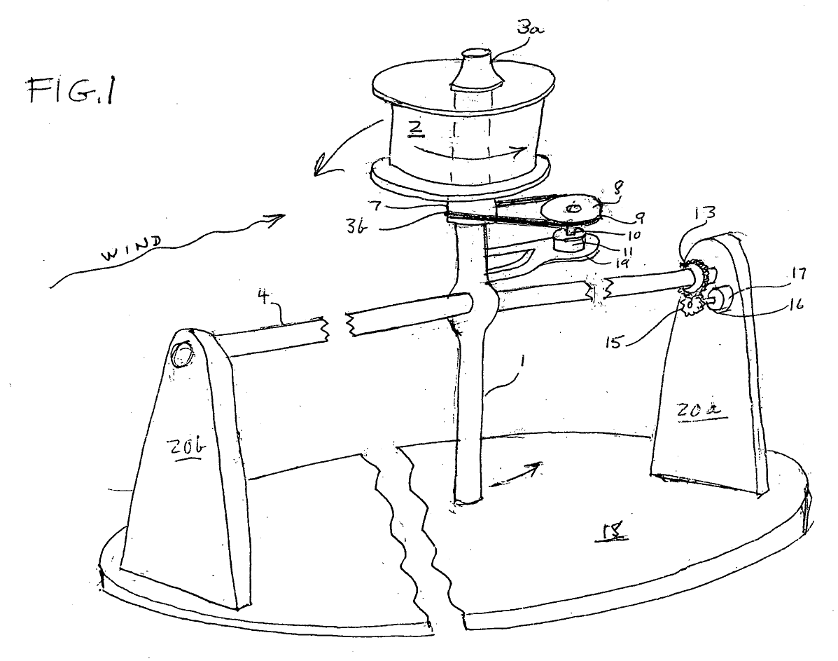

Turning to FIG. 1 we see a pole 1 which is made to operate as a lever with a Flettner Rotor 2 and aerodynamic fences 5,6 mounted so pole 1 serves as the axis of the rotor. Thrust bearings 3a,b secure the rotor to the pole so the rotor may be revolved by motor 11 which is fixedly attached to pole 1 by bracket 19 through the agency of belt 9 and pulleys 7,8. The pole is made to be rotatable about fulcrum rod 4. This rod is supported by brackets 20, 20a which rest on turntable 18. Gear rack 13 is attached to the bottom of pole 1 by pin 12 on one end and on the other end by sleeve 21 attached to turntable 18 by tension spring 22. Pinion gear 15 is located to mesh with the teeth of rack 13. Through shaft 16 pinion gear 15 is operatively connected to electrical generator 17. Also mounted on turntable 18 is tension spring 23 with holder 24. This tension spring is operatively connected to the bottom end of pole 1 opposite pin 12.

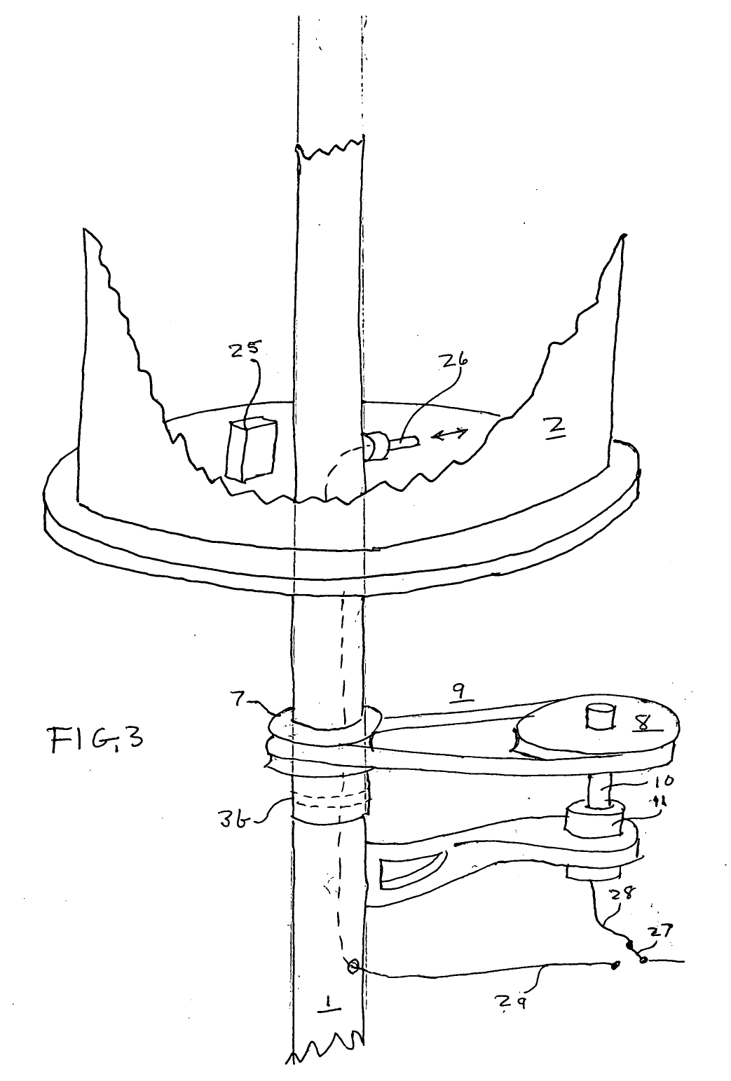

Turning to FIG. 3 we see within the hollow body of the Flettner Rotor a solenoid 25 attached fixedly to pole 1 and a metal stop fixedly attached to the bottom plate of the Rotor 2.

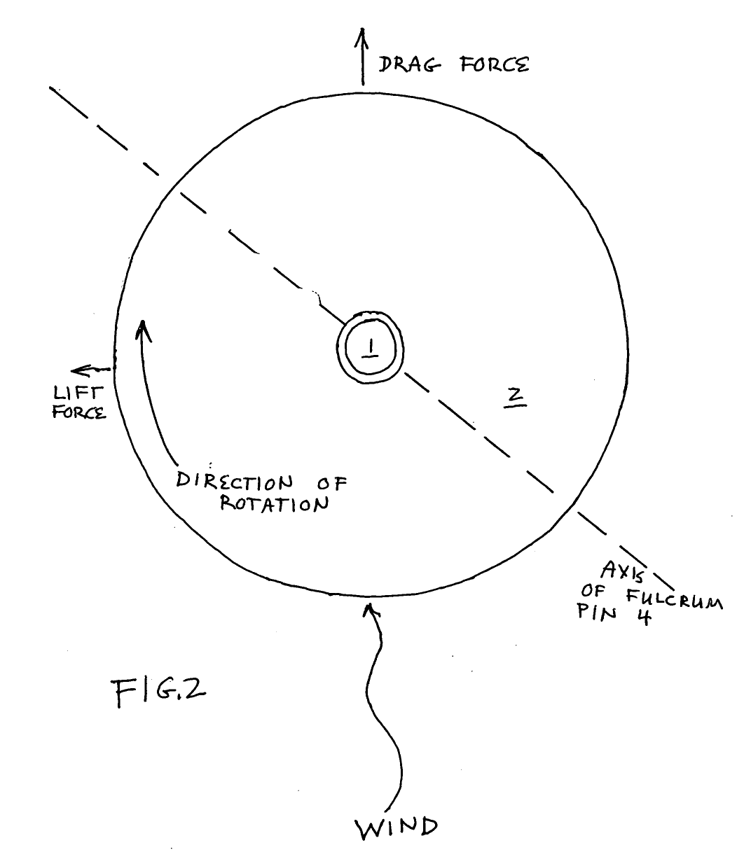

In operation, referring to FIG. 2 motor 11 is made to revolve Flettner Rotor 2 when wind is blowing. A lift force is developed according to the Magnus effect on the surface of the Flettner Rotor 2 perpendicular to the direction of the wind. The usual drag force is developed on the Rotor 2 in the direction of the wind. Turntable 18 is revolved in the direction of the resultant force of the lift and drag forces on the rotor 2. As pole 1 is made to swing by the action of the wind, gear rack 13 is made to travel linearly and cause pinion gear 15 to revolve and thereby operate electrical generator 17.

Wind velocity varies and as this velocity decreases the action of tension spring 23 tends to restore pole 1 to a vertical position causing electrical generator 17 to produce further power.

If this wind velocity variation is not sufficient to produce maximum power output the solenoid may be energized alternately with motor 11 to vary the speed of the Flettner Rotor 2.

I claim:

1-14. (canceled)

15. A device for converting wind energy into electrical energy comprising:
a. a flettner rotor means,
b. an upright support means with a fulcrum around which said flettner rotor means may be rotated, said support means further comprising two vertical bracket means and a horizontal rod located through the upper ends of said bracket means, said rod being rotatable and with said flettner rotor means pole fixedly attached to said horizontal rod,
c. an electric generator means, and
d. an energy transmission means,
so as said flettner rotor means is operated in a wind then electrical energy is produced.
